(19) United States
(12) Patent Application Publication
(10) Pub. No.: US 2018/0307793 A1
(43) Pub. Date: Oct. 25, 2018

(54) SYSTEM AND METHOD FOR CREATING A MODEL-BASED EXPORT FILE

(71) Applicant: General Electric Company, Schenectady, NY (US)

(72) Inventors: Jason Anton Byers, Greenville, SC (US); Jeffrey David Erno, Simpsonville, SC (US); Brian Christopher Wheeler, Simpsonville, SC (US)

(21) Appl. No.: 15/491,698

(22) Filed: Apr. 19, 2017

(51) Int. Cl. G06F 17/50

(52) U.S. Cl. CPC G06F 17/5086

(57) ABSTRACT

A computer-implemented method includes accessing a computer-aided-design (CAD) model. For each component of the CAD model the computer-implemented method includes gathering relevant information pertinent to downstream analysis software, identifying start points, end points, or both, aggregating the relevant information to collected component information, and generating a component file using the collected component information. The component file includes attributes that are interpretable by the downstream analysis software to provide analysis of the CAD model.

### BACKGROUND

The subject matter disclosed herein relates to systems and methods for design of parts, such as industrial machine parts, via computer-aided design (CAD).

Industrial machines, such as gas turbine systems, may be quite complex, utilizing a vast number of piping networks. The piping networks of these industrial machines and machine parts may be designed for a particular purpose, such as a pipe manifold designed to transport fluids (e.g., air, fuel). Because these piping networks may be quite complex, it may be beneficial to improve the efficiency of designing/engineering of machine and machine parts.

### BRIEF DESCRIPTION

Certain embodiments are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a tangible, non-transitory, machine-readable medium includes machine-readable instructions. The machine-readable instructions are to access a computer-aided-design (CAD) model to, for each component of the CAD model, gather relevant information pertinent to downstream analysis software, identify start points, end points, or both, aggregate the relevant information to collected component information, and generate a component file using the collected component information. The component file includes attributes that are interpretable by the downstream analysis software to provide analysis of the CAD model.

In a second embodiment, a system includes a computer processor configured to access a computer-aided-design (CAD) model. For each component of the CAD model, the system is configured to gather relevant information pertinent to downstream analysis software, identify start points, end points, or both, aggregate the relevant information to collected component information, and generate a component file using the collected component information. The component file includes attributes that are interpretable by the downstream analysis software to provide analysis of the CAD model.

In a third embodiment, a computer-implemented method includes accessing a computer-aided-design (CAD) model. For each component of the CAD model the computer-implemented method includes gathering relevant information pertinent to downstream analysis software, identifying start points, end points, or both, aggregating the relevant information to collected component information, and generating a component file using the collected component information. The component file includes attributes that are interpretable by the downstream analysis software to provide analysis of the CAD model.

### BRIEF DESCRIPTION OF THE DRAWINGS

These and other features, aspects, and advantages of the present embodiments will become better understood when the following detailed description is read with reference to the accompanying drawings in which like characters represent like parts throughout the drawings, wherein:

FIG. 1 is a block diagram of an embodiment of a computer-aided technology (CAx) system;

FIG. 2 is a block diagram of a certain components of the CAx system of FIG. 1,

FIG. 3 is block diagram of an industrial system that may be conceived, designed, engineered, manufactured, and/or service and tracked by the CAx system of FIG. 1;

FIG. 4 is a block diagram of an embodiment of a process to import a model design from the CAx system of FIG. 1 into an analysis tool;

FIG. 5 is a block diagram of an embodiment of a downstream portion of the process of FIG. 4;

FIG. 6 is an algorithm of an embodiment of creating a model-based export file for an analysis software tool;

FIG. 7 is an embodiment of a computer aided design (CAD) model from the CAx system of FIG. 1.

FIG. 8 is an embodiment of an model-based export file for an analysis software tool; and

FIG. 9 is an embodiment of an analysis software tool that has analyzed a model design from the CAx system of FIG. 1.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

Designing a machine or part may include certain systems and methods described in more detail below that produce a part design. For example, the part design may be created as a model-based definition included in computer aided design (CAD) model. The techniques described herein allow transferring of CAD models from a solid modeling software (e.g., CAD) to separate downstream software (e.g., stress modeling software), resulting in increased efficiencies by reducing modeling efforts in downstream software (e.g., the stress modeling software).

Models designed with modeling software may include certain associated definitions that enable export of a model-based export file (e.g., piping model file) that may then be imported into downstream software (e.g., stress modeling software). For example, downstream analysis characteristics that are interpretable by the downstream software (e.g., stress modeling software) may be associated and appended to a model-based export file, such that these characteristics are available to the downstream software via an export process of the CAD software. For example, in some embodiments, these downstream analysis characteristics may include positional, geometrical, and attribute data of each component (e.g., pipe, flexhose, tube, etc.) of the model. Positional data may include information regarding coordinates (e.g., position), orientation, position relative to other components, etc. Geometrical data may include information regarding a shape and size of a component. Attribute data may include information regarding material, name, part no., physical properties, etc. In one embodiment, a program (e.g., machine-readable instructions that are executed by a computer processor and are stored on a tangible, non-transitory machine-readable medium) may iterate through a CAD model, collecting and/or calculating the downstream analysis characteristics used by the downstream software. These downstream analysis characteristics may be aggregated into a single file (e.g., the model-based export file) that is importable by the downstream software (e.g., stress modeling software). In some embodiments, attribute data may be defined for a part and stored in a routing library for easy access during future modeling projects. The model-based export file (e.g., a universal piping file) may then be imported into the downstream software (e.g., the stress analysis software). Subsequently, the downstream software (e.g., the stress analysis software) may perform tasks using the model and the downstream analysis characteristics that are obtained from the model-based export file. For example, in some embodiments, stress analysis software may conduct a stress analysis based upon the model and the downstream analysis characteristics provided in the model-based export file.

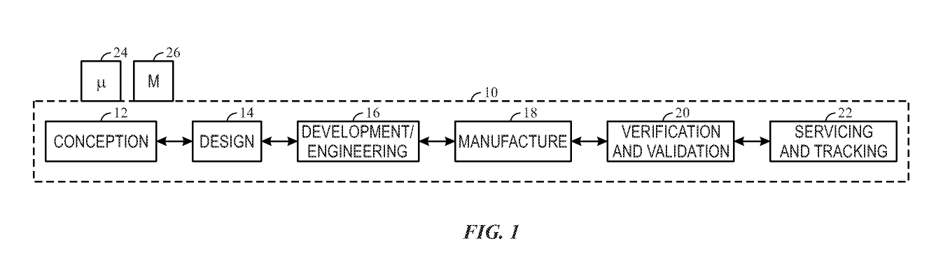

With the foregoing in mind, it may be useful to describe a computer-aided technologies (CAx) system that may incorporate the techniques described herein, for example to improve product lifecycle management (PLM) processes. Accordingly, FIG. 1 illustrates an embodiment of a CAx system 10 suitable for providing for a variety of processes, including PLM processes 12, 14, 16, 18, 20, 22. In the depicted embodiment, the CAx system 10 may include support for execution of conception processes 12. For example, the conception processes 12 may produce a set of specifications (e.g., a set of requirements to be satisfied by a design, a part, a product, or a combination thereof). The conception processes 12 may also produce a concept or prototype for the part or product (e.g., machine). A series of design processes 14 may then use the specifications and/or prototype to produce, for example, one or more design models of the part or product. The design models may include solid/surface modeling, parametric models, wireframe models, vector models, non-uniform rational basis spline (NURBS) models, geometric models, etc. For example, a piping system, which may include pipe components (e.g., pipe, flexhose, tube, etc.), may be produced via design process 14 in modeling software.

Design models may then be further refined and added to via the execution of development/engineering processes 16. The development/engineering processes may, for example, create and apply models such as thermodynamic models, low cycle fatigue (LCF) life prediction models, multibody dynamics and kinematics models, computational fluid dynamics (CFD) models, finite element analysis (FEA) models, and/or 3-dimension to 2-dimension FEA mapping models that may be used to predict the behavior of the part or product during its operation. For example, turbine piping may be modeled to predict fluid flows, pressures, stresses, etc., during operations of a gas turbine engine. More specifically, piping modeled in design software may be analyzed in order to generate a file of the piping that is compatible with stress analysis software. The development/engineering processes 16 may additionally result in tolerances, materials specifications (e.g., material type, material hardness), clearance specifications, etc.

The CAx system 10 may additionally provide for manufacturing processes 18 that may include manufacturing automation support. For example, additive manufacturing models may be derived, such as 3D printing models for material jetting, binder jetting, vat photopolymerization, powder bed fusion, sheet lamination, directed energy deposition, material extrusion, etc., to create the part or product. Other manufacturing models may be derived, such as computer numeric control (CNC) models with G-code to machine or otherwise remove material to produce the part or product (e.g., via milling, lathing, plasma cutting, wire cutting, and so on). Bill of materials (BOM) creation, requisition orders, purchasing orders, etc., may also be provided as part of the manufacture processes 18 (or other PLM processes).

The CAx system 10 may additionally provide for verification and/or validation processes 20 that may include automated inspection of the part or product as well as automated comparison of specifications, requirements, etc. In one example, a coordinate-measuring machine (CMM) process may be used to automate inspection of the part or product. After the part is inspected, results from the CMM process may be automatically generated via an electronic Characteristic Accountability & Verification (eCAV) system. The eCAV system may then communicate with a Data Analysis (DA) system that may derive certain conclusions based around machine capability for the part and may then employ, for example, a logic tree to trigger a calibration to machine settings, to the a producibility advisor system, or a combination thereof. By automatically calibrating machine settings and/or the producibility advisor system, the part may be manufactured more efficiently and accurately.

A servicing and tracking set of processes 22 may also be provided via the CAx system 10. The servicing and tracking processes 22 may log maintenance activities for the part, part replacements, part life (e.g., in fired hours), and so on. As illustrated, the CAx system 10 may include feedback between the processes 12, 14, 16, 18, 20, 22. For example, data from services and tracking processes 22, for example, may be used to redesign the part or product via the design processes 14. Indeed, data from any one of the processes 12, 14, 16, 18, 20, 22 may be used by any other of the processes 12, 14, 16, 18, 20, 22 to improve the part or product or to create a new part or a new product. In this manner, the CAx system 10 may incorporate data from downstream processes and use the data to improve the part or to create a new part.

The CAx system 10 may additionally include one or more processors 24 and a memory system 26 that may execute software programs to perform the disclosed techniques. Moreover, the processors 24 may include multiple microprocessors, one or more “general-purpose” microprocessors, one or more special-purpose microprocessors, and/or one or more application specific integrated circuits (ASICS), or some combination thereof. For example, the processors 24 may include one or more reduced instruction set (RISC) processors. The memory system 26 may store information such as control software, look up tables, configuration data, etc. The memory system 26 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

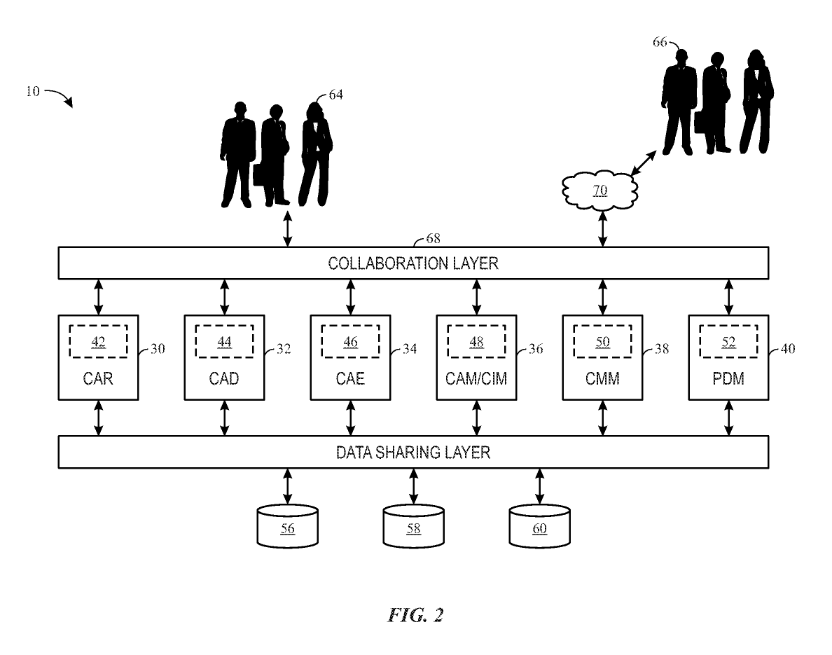

The memory system 26 may store a variety of information, which may be suitable for various purposes. For example, the memory system 26 may store machine-readable and/or processor-executable instructions (e.g., firmware or software) for the processors' 24 execution. In one embodiment, the executable instructions include instructions for a number of PLM systems, for example software systems, as shown in the embodiment of FIG. 2. More specifically, the CAx system 10 embodiment illustrates a computer-aided requirements capture (CAR) system 30, a computer-aided design (CAD) system 32, a computer-aided engineering (CAE) system 34, computer-aided manufacturing/computer-integrated manufacturing (CAM/CIM) system 36, a coordinate-measuring machine (CMM) system 38, and a product data management (PDM) system 40. Each of the systems 30, 32, 34, 36, 38 and 40 may be extensible and/or customizable, accordingly, each system 30 may include an extensibility and customization system 42, 44, 46, 48, 50, and 52, respectively. Additionally, each of the systems 30, 32, 34, 36, 38 and 40 may be stored in a memory system, such as memory system 26, and may be executable via a processor, such as via processors 24.

In the depicted embodiment, the CAR system 30 may provide for entry of requirements and/or specifications, such as dimensions for the part or product, operational conditions that the part or product is expected to encounter (e.g., temperatures, pressures), certifications to be adhered to, quality control requirements, performance requirements, and so on. The CAD system 32 may provide for a graphical user interface suitable to create and manipulate graphical representations of 2D and/or 3D models as described above with respect to the design processes 14. For example, the 3D design models may include solid/surface modeling, parametric models, wireframe models, vector models, non-uniform rational basis spline (NURBS) models, geometric models, etc. The CAD system 32 may provide for the creation and update of the 2D and/or 3D models and related information (e.g., views, drawings, annotations, notes, and so on). Indeed, the CAD system 32 may combine a graphical representation of the part or product with other, related information. In some embodiments the CAD system 32, 2D and/or 3D models of a piping system may be translated to a universal file type that is importable to stress analysis software.

For example, the CAE system 34 may enable creation of various engineering models, such as the models described above with respect to the development/engineering processes 16. For example, the CAE system 34 may apply engineering principles to create models such as thermodynamic models, low cycle fatigue (LCF) life prediction models, multibody dynamics and kinematics models, computational fluid dynamics (CFD) models, finite element analysis (FEA) models, and/or 3-dimension to 2-dimension FEA mapping models. The CAE system 34 may then apply the aforementioned models to analyze certain part or product properties (e.g., physical properties, thermodynamic properties, fluid flow properties, and so on), for example, to better match the requirements and specifications for the part or product. Indeed, the CAE system 34 may perform an analysis (e.g., stress analysis) on a piping file that has been imported from the CAD system 32.

The CAM/CIM system 36 may provide for certain automation and manufacturing efficiencies, for example, by deriving certain programs or code (e.g., G-code) and then executing the programs or code to manufacture the part or product. The CAM/CIM system 36 may support certain automated manufacturing techniques, such as additive (or subtractive) manufacturing techniques, including material jetting, binder jetting, vat photopolymerization, powder bed fusion, sheet lamination, directed energy deposition, material extrusion, milling, lathing, plasma cutting, wire cutting, or a combination thereof. The CMM system 38 may include machinery to automate inspections. For example, probe-based, camera-based, and/or sensor-based machinery may automatically inspect the part or product to ensure compliance with certain design geometries, tolerances, shapes, and so on.

The PDM system 40 may be responsible for the management and publication of data from the systems 30, 32, 34, 36, and/or 38. For example, the systems 30, 32, 34, 36, and/or 38 may communicate with data repositories 56, 58, 60 via a data sharing layer 62. The PDM system 40 may then manage collaboration between the systems 30, 32, 34, 36, and/or 38 by providing for data translation services, versioning support, archive management, notices of updates, and so on. The PDM system 40 may additionally provide for business support such as interfacing with supplier/vendor systems and/or logistics systems for purchasing, invoicing, order tracking, and so on. The PDM system 40 may also interface with service/logging systems (e.g., service center data management systems) to aid in tracking the maintenance and life cycle of the part or product as it undergoes operations. Teams 64, 66 may collaborate with team members via a collaboration layer 68. The collaboration layer may include web interfaces, messaging systems, file drop/pickup systems, etc., suitable for sharing information and a variety of data. The collaboration layer 68 may also include cloud-based systems 70 or communicate with the cloud-based systems 70 that may provide for decentralized computing services and file storage. For example, portions (or all) of the systems 30, 32, 34, 36, 38 may be stored in the cloud 70 and/or accessible via the cloud 70.

The extensibility and customization systems 42, 44, 46, 48, 50, and 52 may provide for functionality not found natively in the CAR system 30, the CAD system 32, the CAM/CIM system 36, the CMM system 38 and/or the PDM system 40. For example, computer code or instructions may be added to the systems 30, 32, 34, 36, and/or 38 via shared libraries, modules, software subsystems and the like, included in the extensibility and customization systems 42, 44, 46, 48, 50, and/or 52. The extensibility and customization systems 42, 44, 46, 48, 50, and 52 may also use application programming interfaces (APIs) included in their respective systems 30, 32, 34, 36, and 38 to execute certain functions, objects, shared data, software systems, and so on, useful in extending the capabilities of the CAR system 30, the CAD system 32, the CAM/CIM system 36, the CMM system 38 and/or the PDM system 40. By enabling the processes 12, 14, 16, 18, 20, and 22, for example, via the systems 30, 32, 34, 36, and 38 and their respective extensibility and customization systems 42, 44, 46, 48, 50, and 52, the techniques described herein may provide for a more efficient “cradle-to-grave” product lifecycle management.

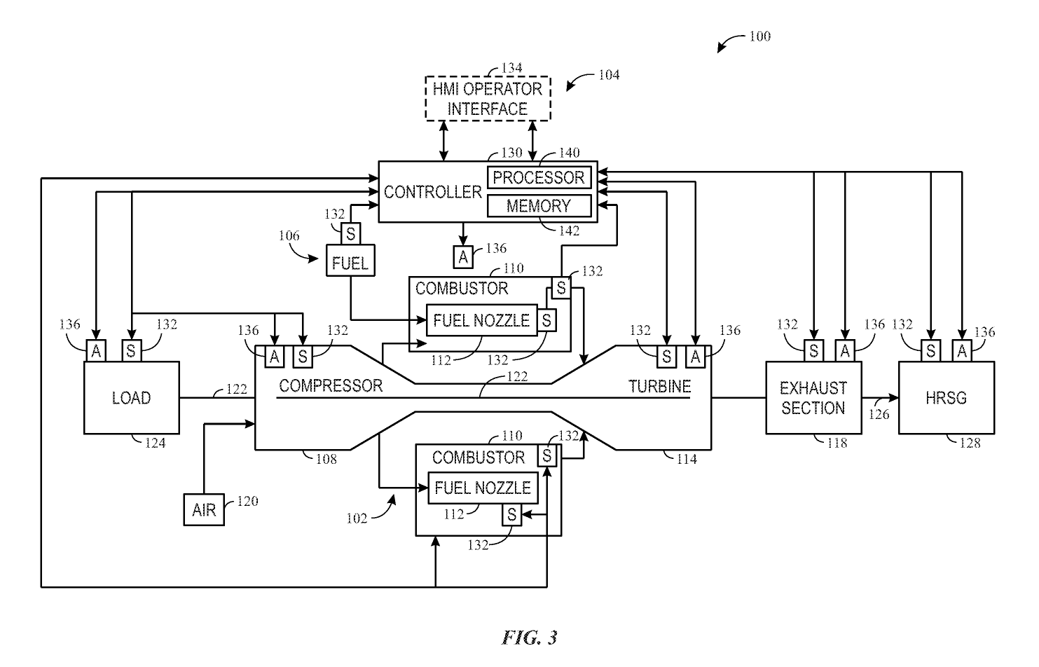

It may be beneficial to describe a machine that would incorporate one or more parts manufactured and tracked by the processes 12, 14, 16, 18, 20, and 22, for example, via the CAx system 10. Accordingly, FIG. 3 illustrates an example of a power production system 100 that may be entirely (or partially) conceived, designed, engineered, manufactured, serviced, and tracked by the CAx system 10. As illustrated in FIG. 1, the power production system 100 includes a gas turbine system 102, a monitoring and control system 104, and a fuel supply system 106. The gas turbine system 102 may include a compressor 108, combustion systems 110, fuel nozzles 112, a gas turbine 114, and an exhaust section 118. During operation, the gas turbine system 102 may pull air 120 into the compressor 108, which may then compress the air 120 and move the air 120 to the combustion system 110 (e.g., which may include a number of combustors). In the combustion system 110, the fuel nozzle 112 (or a number of fuel nozzles 112) may inject fuel that mixes with the compressed air 120 to create, for example, an air-fuel mixture.

The air-fuel mixture may combust in the combustion system 110 to generate hot combustion gases, which flow downstream into the turbine 114 to drive one or more turbine stages. For example, the combustion gases may move through the turbine 114 to drive one or more stages of turbine blades, which may in turn drive rotation of a shaft 122. The shaft 122 may connect to a load 124, such as a generator that uses the torque of the shaft 122 to produce electricity. After passing through the turbine 114, the hot combustion gases may vent as exhaust gases 126 into the environment by way of the exhaust section 118. The exhaust gas 126 may include gases such as carbon dioxide (CO₂), carbon monoxide (CO), nitrogen oxides (NOₓ), and so forth.

The exhaust gas 126 may include thermal energy, and the thermal energy may be recovered by a heat recovery steam generation (HRSG) system 128. In combined cycle systems, such as the power plant 100, hot exhaust 126 may flow from the gas turbine 114 and pass to the HRSG 128, where it may be used to generate high-pressure, high-temperature steam. The steam produced by the HRSG 128 may then be passed through a steam turbine engine for further power generation. In addition, the produced steam may also be supplied to any other processes where steam may be used, such as to a gasifier used to combust the fuel to produce the untreated syngas. The gas turbine engine generation cycle is often referred to as the “topping cycle,” whereas the steam turbine engine generation cycle is often referred to as the “bottoming cycle.” Combining these two cycles may lead to greater efficiencies in both cycles. In particular, exhaust heat from the topping cycle may be captured and used to generate steam for use in the bottoming cycle.

In certain embodiments, the system 100 may also include a controller 130. The controller 130 may be communicatively coupled to a number of sensors 132, a human machine interface (HMI) operator interface 134, and one or more actuators 136 suitable for controlling components of the system 100. The actuators 136 may include valves, switches, positioners, pumps, etc., suitable for controlling the various components of the system 100. The controller 130 may receive data from the sensors 132, and may be used to control the compressor 108, the combustors 110, the turbine 114, the exhaust section 118, the load 124, the HRSG 128, and so forth.

In certain embodiments, the HMI operator interface 134 may be executable by one or more computer systems of the system 100. A plant operator may interface with the industrial system 10 via the HMI operator interface 134. Accordingly, the HMI operator interface 134 may include various input and output devices (e.g., mouse, keyboard, monitor, touch screen, or other suitable input and/or output device) such that the plant operator may provide commands (e.g., control and/or operational commands) to the controller 130.

The controller 130 may include a processor(s) 140 (e.g., a microprocessor(s)) that may execute software programs to perform the disclosed techniques. Moreover, the processor 140 may include multiple microprocessors, one or more “general-purpose” microprocessors, one or more special-purpose microprocessors, and/or one or more application specific integrated circuits (ASICS), or some combination thereof. For example, the processor 39 may include one or more reduced instruction set (RISC) processors. The controller 130 may include a memory device 142 that may store information such as control software, look up tables, configuration data, etc. The memory device 142 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

Furthermore, the power production system 10 may include parts that have been designed utilizing computer aided design (CAD) software. Before implementation into the power production system 10, these parts may have been analyzed via analysis software tools (e.g., stress analysis software). Accordingly, the parts may have originally been designed via CAD software and underwent a process to become compatible to the analysis software tools. This method may now be discussed in reference to the following figures.

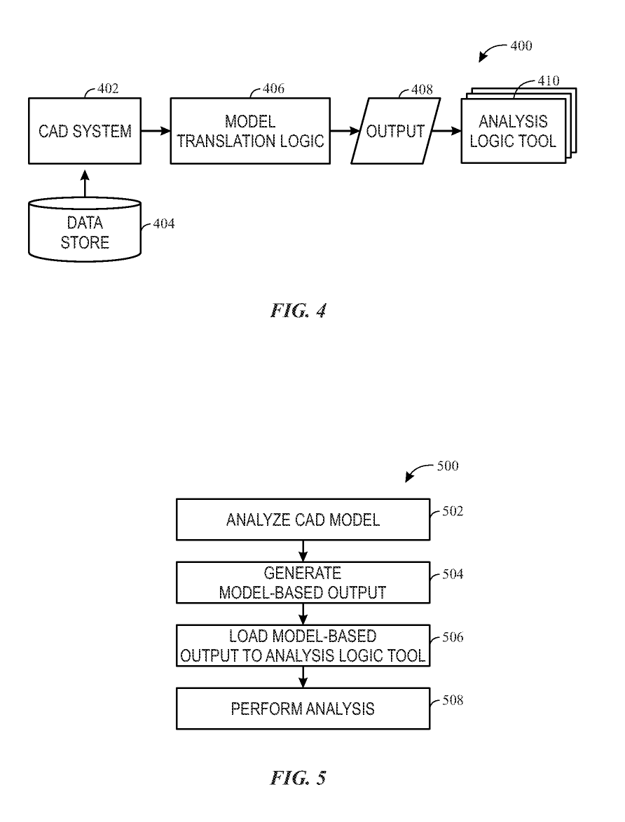

FIG. 4 is a block diagram of an embodiment of a process 400 to import a computer-aided model and associated downstream analysis characteristics from the CAx system 10 of FIG. 1 into downstream software, such that the downstream software may make use of the computer-aided model without significant additional modeling efforts.

As mentioned above, a user may produce a design (e.g., piping design) in a computer aided design (CAD) system 402. The user may also retrieve a design (e.g., piping design) from a data store 404, to view or modify within the CAD system 402. In some embodiments, the design may be a piping design having one or more piping components (e.g., components designed to convey fluids and/or gases, such as piping, flexhose, tubing, joints, etc.) as seen in FIG. 7, for example.

Model translation logic 406 may be applied to the design. Model translation logic 406 may gather data from components of the design such as positional, geometrical, and attribute data related to the model. In some embodiments, the model translation logic 506 may calculate this data for each relevant component that does not already have such a completed data calculation (or if a modification to the component has altered the existing data calculation). For example, in some embodiments, an end point for a component may not be defined within the CAD system 402. Accordingly, math (e.g., vector logic) may be applied to calculate the undefined end point (e.g., location of the end point). More specifically, the model translation logic 406 may analyze each component of a model, gathering and/or calculating positional, geometrical, and attribute data of each component, and compile the data into an output 408 (e.g., the model-based output file, discussed above). The output 408 may be a widely compatible output file that can be imported into various downstream software systems (e.g., analysis software tools 410).

Because the output 408 includes the calculated data of the model translation logic 406, additional modelling in the downstream software may be reduced. For example, the analysis logic tools 410 may acquire the model and/or the downstream analysis characteristics from the output 406 and may analyze this data for stress calculations, thermal properties, fluid flow characteristics, etc. In some embodiments, the process 400 may directly pass the model and/or the downstream analysis characteristics to the downstream systems (e.g., the analysis logic tool 410), such that an output file 408 is not generated. In such embodiments, packets of data including the model and/or the downstream analysis characteristics may be directly imported into the downstream systems 410 from the CAD system 402.

FIG. 5 is a block diagram of an embodiment of an analysis process 500 that may use the data provided by the output 408 of process 400 of FIG. 4. In block 502, a CAD model, such as CAD model in the form of a piping system 700 of FIG. 7, is analyzed. Analysis of the CAD model may include traversing the model to gather/calculate data on each component (e.g., pipe, flexhose, tube, etc.). As mentioned above, the gathered/calculated data may include positional, geometrical, and attribute data. Positional, geometrical, and attribute data may also include part names (e.g., component codes), weight, size, length, end point locations, port (e.g., tube hole) characteristics, material, position, shape, orientation, and/or other data that may be useful to the downstream software.

Some models may include components having their own respective coordinate system with a respective orientation (e.g., rotation). In some embodiments, the downstream software may expect that components of the model be referenced from a common coordinate system (e.g., a common plane and/or orientation). Accordingly, gathering/calculating positional and/or orientation data may include identifying a common coordinate system of each component of the CAD model. As such, each coordinate system may be generalized to fit a single coordinate system. In some embodiments, end points may be calculated using vector math.

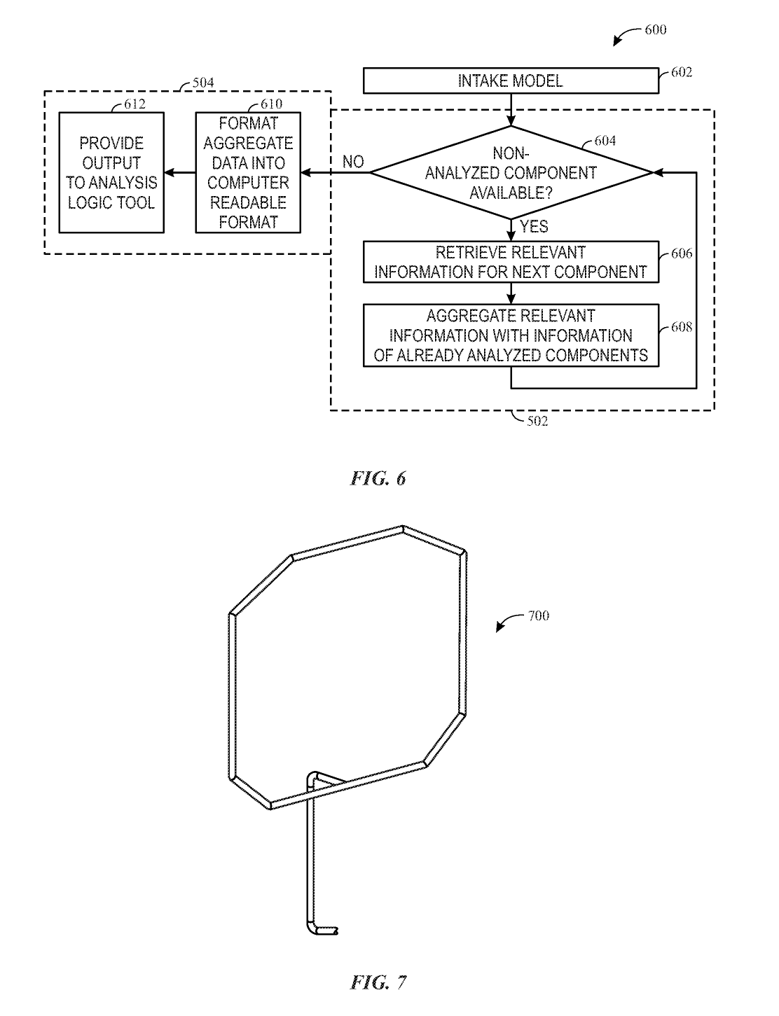

At block 504, a model-based output is generated. The model-based output may be an output file that contains a compilation of the data acquired at block 502. Blocks 502 and 504 may be further expanded upon in the discussion of FIG. 6. Additionally, or in the alternative, the model-based output may also contain data acquired from a routing library. A routing library (e.g., a routing library associated with modeling software) may store data associated with standard or previously defined modeling pieces (e.g., a pipe, a flexhose, a joint, a plane, a cube, etc.). Accordingly, a user may retrieve data associated with a modeling component in order to import the modeling component and its associated data into a CAD model. The model-based output may contain a single file for the entire 3D and/or 2D CAD model, and in some embodiments, the model-based output file may contain a file for each component of the CAD model. FIG. 8 illustrates an embodiment of the model-based output.

The use of a routing library will now be discussed. If an existing model and/or component and its associated data (e.g., positional, geometrical and attribute data) is to be imported to downstream analysis software, the routing library may first be updated to reflect its associated data (which may be representative of component attributes). For example, the routing library may be updated with a component ID associated with each component. The component ID may indicate, for each component, a type of component (e.g., flange, tee, plug, olet, etc.). In some embodiments, the routing library may be updated with a symbol key and/or a nominal pipe size of a component. Generally, each component in a model may be defined with respect to relevant information (e.g., symbol key, component number, component ID, nominal pipe size, etc.) that may be updated in the routing library. The symbol key is used to identify specific types of components (e.g. for a flange: slip on, weld neck, blind, etc.). The relevant information may include a component type, coordinates and size of end points, and/or a shape used to represent the component. If the relevant information for a component is not already stored in the routing library, the relevant information may be gathered/aggregated via model translation logic (e.g., block 406), analysis of the CAD model (e.g., at block 502), manually entered via an input, or a combination thereof. Further, if a new model and/or component is to be imported to downstream analysis software, the new model and/or components may initially be designed (via CAD software) with components that were previously defined (e.g., with respect to the relevant information mentioned above) in the routing library. However, if one or more components used in the new model were not previously defined in the routing library, the relevant information may be gathered/aggregated via model translation logic (e.g., block 406), analysis of the CAD model (e.g., at block 502), manually entered via an input, or a combination thereof. The relevant information may then be stored in the routing library as described above.

At block 506, the model-based output may be imported into a downstream software (e.g., the analysis logic tool). In some embodiments, the model-based output may first be translated to a text-based routing and component file (e.g., a piping component file (PCF)) and, in turn, translated to a neutral translated language (NTL) before being loaded in downstream software (e.g., the analysis logic tool). The PCF format allows multiple types of analysis software to import the information and translate to their own neutral language. For example, the model-based output may be written in a format that is generally acceptable (e.g., PCF) to common analysis logic tools (e.g., a format using data definitions from a common routing library) which can then take that file and translate it to the NTL format that corresponds with their software. In some embodiments, the model-based output may be tailored to be compatible with the downstream software upon generation (e.g., because it is written in a language that is compatible with the downstream software (e.g., analysis logic tool software)).

Because data representing the model is provided in the output that is imported into the downstream software, the downstream software may generate a replicated 3D and/or 2D CAD model based on data included in the model-based output. Additionally, the downstream software may run additional tasks using the defined characteristics provided in the output. The analysis logic tool may be capable of running stress analysis, thermal analysis, flow analysis, etc. on the replicated CAD model.

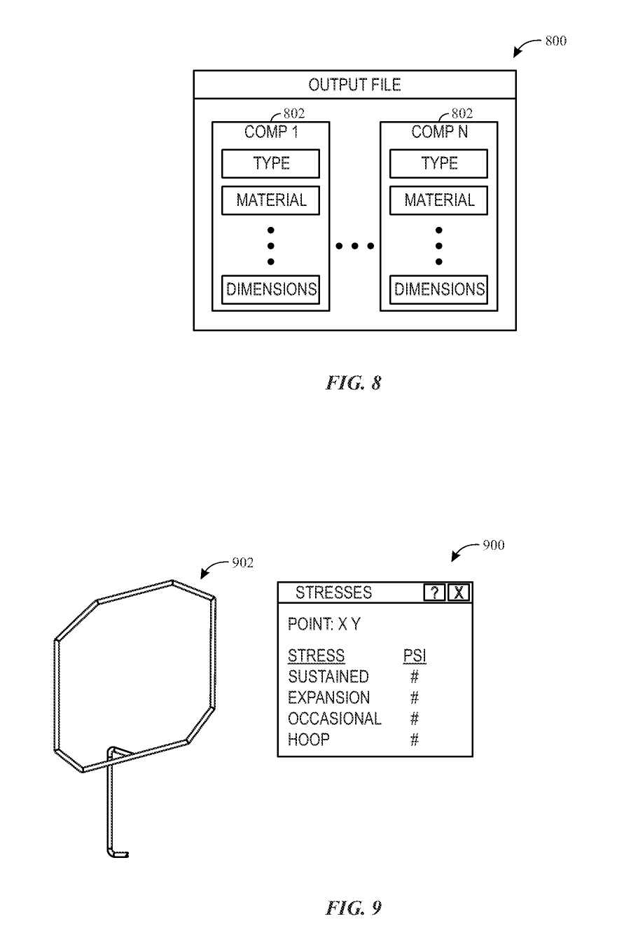

At block 508, analysis may be performed on the on the replicated CAD model. As mentioned above, the analysis may perform a stress analysis, a thermal analysis, a flow analysis, etc. on the model-based output. In some embodiments, the analysis logic tool may display results of the performed analysis in tabular form, and in some embodiments, the analysis logic tool may alter a color scheme of the replicated CAD model to represent results of the performed analysis. An example of the analysis results may be seen in FIG. 9.

FIG. 6 is a process 600 of creating a model-based export file for an analysis software tool, in accordance with an embodiment. As mentioned above, portions of the process 600 may be embodiments of blocks 502 and 504 discussed in reference to FIG. 5. First, a processor (e.g., one or more of the processors 24) may receive (e.g., intake) a 3D and/or 2D CAD model (block 602).

The processor may traverse the components of the model to analyze the components for data to be provided in the model-based export file. To do this, the processor decides if there is a non-analyzed component (e.g., pipe, flexhose, tube, elbow, joint, etc.) available (decision block 604).

If non-analyzed components are available, the processor continues to block 606. At block 606, the processor may retrieve relevant information for the next non-analyzed component. Retrieving relevant information may include gathering and/or calculating the relevant information. As discussed above, relevant information may include positional, geometrical, and/or attribute information of a component. For example, positional, geometrical and attribute information may include a component definition, a component name (e.g., component code), a component weight, a component size, a component length, a component end point location, a component material, a component position, a component shape, a component orientation, etc. In some embodiments, some of the relevant information may be retrieved from a routing library. Further, some of the relevant information may be obtained through user input. Some of the relevant information may be calculated as well. For example, if data indicating component end points is not associated with a component (e.g., data not found in a routing library), then vector math may be performed on existing data using attributes such as thickness, length, and/or orientation of components to determine where the endpoints are located. As may be appreciated, these endpoints may be used by the downstream software to identify an exact location, orientation, and/or geometry of a component.

The use of a routing library will now be discussed. If an existing model and its associated relevant data is to be imported to downstream analysis software

Next, the process 600 moves to block 608. At block 608, the processor may aggregate relevant information with information of the already analyzed components. For example, after analyzing a component, the processor may append the relevant information to relevant information that has been previously gathered on other components. In some embodiments, the processor may continuously append the relevant data to a file in a computer-readable format. Next, the processor once again determines if there is another non-analyzed computer-readable component available (block 604). Once the processor has analyzed all of the components of the CAD file and gathered all of the relevant information on all of the components (i.e., there are no more non-analyzed components available as determined at decision block 604), the process 600 may move to block 610.

At block 610, the processor may aggregate (e.g., compile) the gathered/calculated relevant data into a computer-readable format. In some embodiments, aggregating the relevant data may include converting the data to Isogen®, SQL, C#, C++, Java, JavaScript, PHP, and/or Python-based data stores. In some embodiments, aggregated data may conform to a pre-existing definition-based platform which may be importable by a variety of downstream software packages/analysis logic software tools. Further, in some embodiments, the aggregated data is converted to an expected file type for a particular analysis software tool/downstream software package. Finally, at block 612, the processor may provide an output (e.g., aggregated data) to an analysis logic tool/downstream software package. In some embodiments, the analysis logic software tool/downstream software package may be linked to the original CAD model so that when a change is made to the original CAD model, the change is reflected in the replicated 3D CAD model in the analysis logic tool/downstream software package. For example, in some embodiments, when the output is imported into the downstream software package, data of the model-based export file may include an indicator that indicates a particular location where model updates may be obtained. The downstream software may use this indication to periodically poll for updates to the model. When such updates are available, the updates may be retrieved and applied to the replicated CAD model. In other embodiments, the CAD software may automatically provide updates to known downstream software packages that it knows.

FIG. 7 is an embodiment of a computer aided design (CAD) model from the CAx system of FIG. 1. The current embodiment of a CAD model is in the form of a piping system 700. In some embodiments, the piping system 700 may be representative of a piping system that would be utilized in the power production system 100 of FIG. 3. The piping system 700 may be an assembly of components such as pipes, flexhoses, tubes, bends, etc. Further, some of the components may be in different planes with separate coordinate systems. As such, to be importable into an analysis software tool, the separate coordinate systems of the piping system 700 may be generalized with respect to a single coordinate system.

FIG. 8 is an embodiment of a model-based export file 800 (e.g., output file) for an analysis software tool. As discussed above, the model-based export file 800 may be a compilation of information 802 related to components of a 3D and/or 2D CAD model assembly. The file may contain information 802 on one or more (e.g., 1 to N) components. The information 802 may include component material, dimensions, weight, description, item code, etc. As discussed above, the model-based export file 800 may be in the form several file types. The file type may correspond to an expected file type of the specific analysis software tool. In some embodiments, the model-based export file 800 may be compatible to one or more software analysis tools. In some embodiments, information contained in the model-based export file 800 may be stored in a routing library for access in future projects and/or updates.

FIG. 9 is an embodiment of analysis results 900 from an analysis software tool that has analyzed a model design 902 from the CAx system of FIG. 1. For reference, the replicated model 902 may be representative of the piping system 700 discussed in reference to FIG. 7. In the current embodiment, the analysis software provides results of a stress analysis of the model, based upon data provided in the model-based output. In some embodiments, the analysis software tool may perform thermal analysis, flow analysis, etc., on the replicated model 902. In some embodiments, the analysis software may be capable of analyzing individual points for stress, flow, etc. Furthermore, it should be noted that although the replicated model 902 is of a piping assembly, in some embodiments, the replicated model 902 may be in the form of any suitable 3D and/or 2D model of a part or assembly.

In some embodiments, imported models may have certain data associated with it that downstream software may analyze in order to perform an analysis. For example, imported models may have data associated with it that indicates, a material type, a thickness of material, locations of one or more joints, etc. The imported models may also have other parameters that the downstream software may utilize in an analyzation process (e.g., stress analysis, flow analysis, thermal analysis).

Technical effects of the current disclosure include a method to create an output file that is compatible with downstream software/analysis software tools (e.g., stress analysis). The output file may be representative of an assembly (e.g., piping assembly) that was designed while utilizing computer aided design (CAD) software. The method to create the output file may include iterating through the assembly to gather/calculate relevant component information to create the output file. Relevant component information may include positional, geometrical, and/or attribute information. For example, gathered information may include component weight, length, material type, component name, etc. Calculated information may include generalizing coordinate systems of each component to remap each component's coordinate system to the generalized coordinate system. Calculated information may also include using vector math to calculate endpoints of a component. Overall, the methods and systems disclosed herein may provide for an efficient and accurate creation of an analysis (e.g., stress analysis) capable model based on a CAD model.

This written description uses examples to disclose certain embodiments, including the best mode, and also to enable any person skilled in the art to practice these embodiments, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A tangible, non-transitory, machine-readable medium, comprising, machine-readable instructions to:
access a computer-aided-design (CAD) model;
for each component of the CAD model:
gather relevant information pertinent to downstream analysis software;
identify start points, end points, or both;
aggregate the relevant information to collected component information;
generate a component file using the collected component information, wherein the component file comprises attributes that are interpretable by the downstream analysis software to provide analysis of the CAD model.

2. The machine-readable medium of claim 1, comprising machine-readable instructions to:
update a routing database with at least a portion of the attributes, such that the collected component information comprises the portion of the attributes.

3. The machine-readable medium of claim 2, comprising machine-readable instructions to:
update the routing database with the portion of the attributes prior to placement of at least one new component in the CAD model, wherein the portion of the attributes are associated with the at least one new component;
after the at least one new component is placed in the CAD model, aggregate the portion of the attributes from the routing database to the collected component information.

4. The machine-readable medium of claim 2, comprising machine-readable instructions to:
update the routing database with the portion of the attributes after placement of at least one previously placed component, wherein the portion of the attributes are associated with the at least one previously placed component; and
aggregate the portion of the attributes from the routing database to the collected component information.

5. The machine-readable medium of claim 2, wherein the portion of the attributes comprise at least one symbol key and at least one component ID.

6. The machine-readable medium of claim 2, wherein the portion of the attributes comprise a component identifier number, a nominal pipe size, or both.

7. The machine-readable medium of claim 1, wherein the attributes comprise positional information, geometrical information, characteristic information, or a combination thereof, of one or more components of the CAD model.

8. The machine-readable medium of claim 1, wherein the downstream analysis software comprises a pipe stress analysis tool.

9. The machine-readable medium of claim 1, wherein the component file is formatted in a text-based routing and component file that is translatable to a neutral translated language (NTL) interpretable by a plurality of analysis tool software programs.

10. The machine-readable medium of claim 1, comprising machine-readable instructions to:
when an end point location is not available, calculate the end point location using vector math.

11. The machine-readable medium of claim 10, comprising machine-readable instructions to:
calculate the end point location based upon a thickness of a component, port characteristics of the component, or a combination thereof.

12. A system, comprising a computer processor configured to:
access a computer-aided-design (CAD) model;
for each component of the CAD model:
gather relevant information pertinent to downstream analysis software;
identify start points, end points, or both;
aggregate the relevant information to collected component information;
generate a component file using the collected component information, wherein the component file comprises attributes that are interpretable by the downstream analysis software to provide analysis of the CAD model.

13. The system of claim 12, wherein the processor is configured to update a routing database with at least a portion of the attributes, such that the collected component information comprises the portion of the attributes.

14. The system of claim 13, wherein the portion of the attributes comprise at least one symbol key, a component identifier number, and a nominal pipe size.

15. The system of claim 12, wherein the processor is configured to update the routing database with at least a second portion of the attributes, the second portion of the attributes comprising: pipe schedule, pressure ratings, material, size, wires, connectors, associative connections, or any combination thereof.

16. The system of claim 12, wherein the downstream analysis software comprises a pipe stress analysis tool.

17. A computer-implemented method, comprising:
accessing a computer-aided-design (CAD) model;
for each component of the CAD model:
gathering relevant information pertinent to downstream analysis software;
identifying start points, end points, or both;
aggregating the relevant information to collected component information;
generating a component file using the collected component information, wherein the component file comprises attributes that are interpretable by the downstream analysis software to provide analysis of the CAD model.

18. A computer-implemented method of claim 17, comprising:
accessing a computer-aided-design (CAD) model;
for each component of the CAD model:
updating a routing database with at least a portion of the attributes, such that the collected component information comprises the portion of the attributes.

19. The computer-implemented method of claim 17, wherein the relevant information comprises positional information, geometrical information, characteristic information, or a combination thereof.

20. The computer-implemented method of claim 17, wherein the downstream analysis software periodically polls the CAD model for updates and aggregates the updates to the collected component information.
